(19) United States
(12) Patent Application Publication
(10) Pub. No.: US 2026/0323443 A1
(43) Pub. Date: Oct. 15, 2026

(54) PREDICTION-BASED LOWER-LAYER TRIGGERED MOBILITY PROCEDURE IN A WIRELESS COMMUNICATION SYSTEM

(71) Applicant: Google LLC, Mountain View, CA (US)

(72) Inventors: Yushu ZHANG, Beijing (CN); Jia-Hong LIOU, Taipei City (TW)

(21) Appl. No.: 19/481,878

(22) PCT Filed: May 31, 2023
(86) PCT No.: PCT/CN2023/097414

§ 371 Date: Nov. 5, 2025

(51) Int. Cl. H04W 36/08; H04W 36/00

(52) U.S. Cl. CPC H04W 36/08; H04W 36/0016

(57) ABSTRACT

This disclosure provides systems, devices, apparatus, and methods, including computer programs encoded on storage media, for a prediction-based LTM procedure. A first wireless device, which can be a UE (102) or a network entity (104), communicates (314, 414), with a second wireless device, a CSC including a first indication type of a plurality of indication types. The first indication type is for switching from a source cell to a candidate cell. The second wireless device can also be a UE (102) or a network entity (104). The communicating (314, 414) the CSC may include transmitting or receiving, to/from the second wireless device, the CSC to switch the first/second wireless device from the source cell to the candidate cell. The first wireless device performs (320), with the second wireless device, an LTM procedure according to the prediction-based indication.

### TECHNICAL FIELD

The present disclosure relates generally to wireless communication, and more particularly, to a lower-layer triggered mobility (LTM) procedure.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a UE and a network entity may perform a lower-layer triggered mobility (LTM) procedure to reduce latency associated with handover/cell-switching procedures. However, some LTM techniques may cause increased UE power consumption, high overhead, and/or time-frequency resource waste associated with sending triggering signals and/or receiving corresponding feedback.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) and a network entity, such as a base station or a unit of a base station, may implement a lower-layer triggered mobility (LTM) procedure to reduce latency associated with handover/cell-switching procedures of the UE. For example, in comparison to a Layer 3 (L3) cell-switching procedure, which may have increased latency as a result of multiple higher layer message exchanges and reconfiguration, a Layer 1/Layer 2 (L1/L2) cell switching procedure may use a triggering indication to switch to a candidate cell configured to the UE via a UE configuration message. The network entity may configure the UE with one or more candidate cells prior to transmitting a cell-switching command (CSC) to the UE, so that when the UE moves from a source cell toward a configured candidate cell, the network entity can transmit the CSC to the UE for the UE to switch from the source cell to the configured candidate cell with reduced latency.

The network entity and/or the UE can implement machine learning (ML) models to improve an overall system performance associated with LTM procedures. For example, the network entity and/or the UE may use an ML model to predict one or more candidate or target cells that the UE is expected to switch to at a later point in time. The prediction can also be for a plurality of candidate or target cells associated with a sequence of cell switches of the UE. Either the network entity or the UE can implement the cell-switching prediction based on a CSC message that includes a prediction-based indication for one or more cell-switches. That is, in some examples, the network entity performs the cell-switching prediction and transmits the CSC message to the UE. In other examples, the UE performs the cell-switching prediction and transmits the CSC message to the network entity. In some examples, the CSC message from the UE to the network entity may be a cell switching request or a cell switching report. CSC messages based on cell switching prediction(s) can conserve a UE battery power by reducing a number of cell quality measurement instances, reduce overhead associated with triggering signals, and/or reduce time-frequency resource waste associated with sending a triggering signal and receiving corresponding feedback.

According to some aspects, a first wireless device, which can be a UE or a network entity, communicates, with a second wireless device, a CSC including a first indication type of a plurality of indication types. The first indication type is for switching from a source cell to a candidate cell. The second wireless device can also be a UE or a network entity. For example, if the first wireless device is a UE, the second wireless device is a network entity, or vice-versa. The communicating the CSC may include transmitting or receiving, to/from the second wireless device, the CSC to switch the first/second wireless device from the source cell to the candidate cell. The first wireless device performs, with the second wireless device, an LTM procedure according to the prediction-based indication.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates a diagram of a base station transmitting a cell-switching command (CSC) to a UE.

FIG. 3 illustrates a signaling diagram for configuring and implementing a prediction-based CSC according to a cell-switching prediction at a network entity.

FIG. 4 illustrates a signaling diagram for configuring and implementing a prediction-based CSC according to a cell-switching prediction at a UE.

FIG. 5 is a flowchart of a method of wireless communication at a first wireless device.

FIG. 6 is a diagram illustrating a hardware implementation for an example UE apparatus.

FIG. 7 is a diagram illustrating a hardware implementation for one or more example network entities.

### DETAILED DESCRIPTION

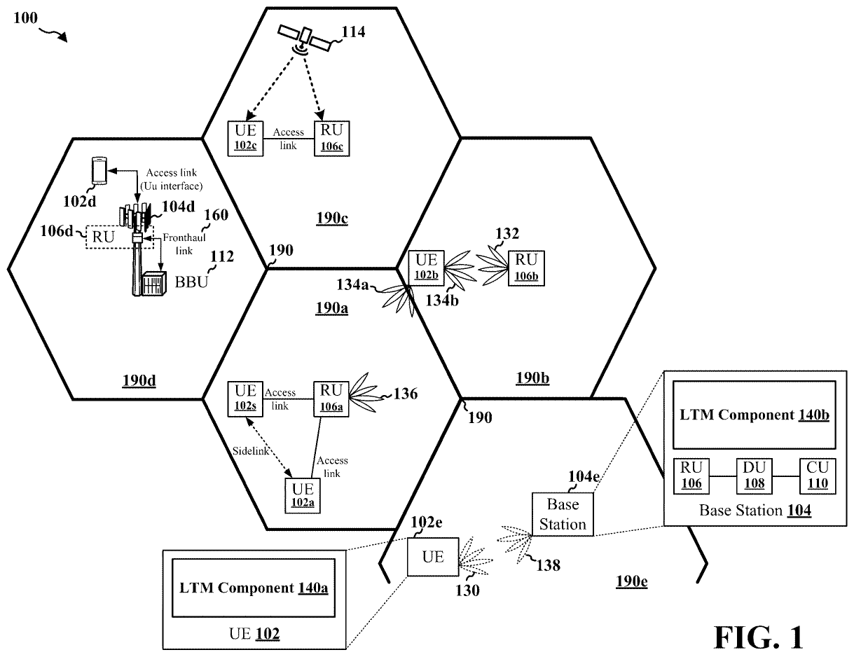

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102, which may correspond to a first wireless device or a second wireless device, may include a lower-layer triggered mobility (LTM) component 140a. Similarly, any of the base stations 104 or network entities of the base stations 104 may include an LTM component 140b. The LTM component 140a/140b is included at least at a first wireless device and configured to: communicate, with a second wireless device, a cell-switching command (CSC) including a first indication type of a plurality of indication types, the first indication type for switching from a source cell to a candidate cell; and perform, with the second wireless device, an LTM procedure according to the first indication type. In some examples, the first indication type includes a prediction-based indication for switching from a source cell to candidate cell(s). In other examples, the first indication type includes a sequential LTM procedure indication (e.g., sequential candidate cell switches). In still other examples, the first indication type includes a combination of prediction-based indication and sequential LTM procedure indication.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

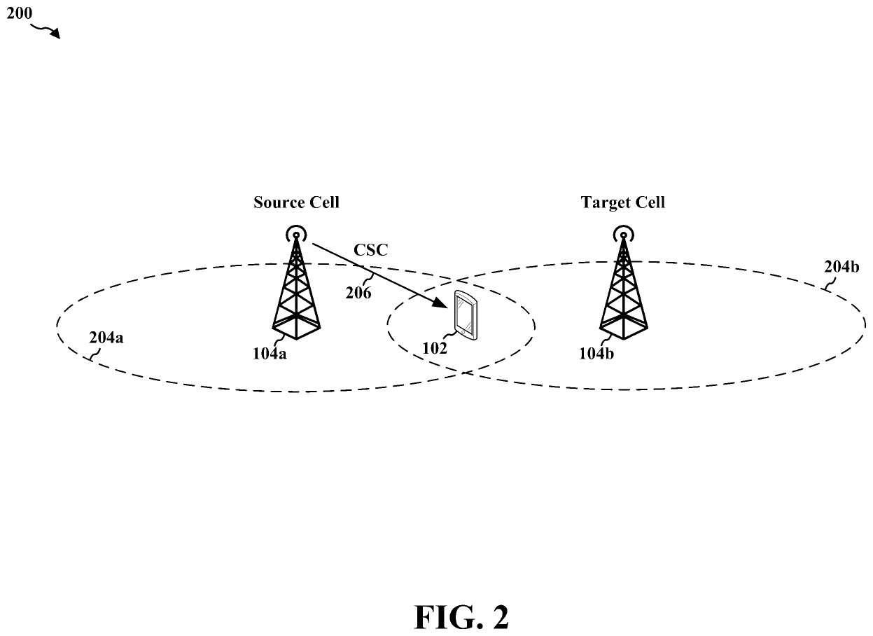

FIG. 2 illustrates a diagram 200 of a first base station 104a transmitting a cell-switching command (CSC) 206 to a UE 102 to switch the UE 102 from a source cell 204a of the first base station 104a to a target cell 204b of a second base station 104b. A lower-layer triggered mobility (LTM) procedure may be implemented to reduce latency associated with cell-switching/handover procedures for the UE 102. For example, in comparison to a Layer 3 (L3) cell-switching procedure, which may include increased latency as a result of multiple higher layer message exchanges and reconfiguration, a Layer 1/Layer 2 (L1/L2) cell switching procedure may be based on triggering a configured candidate cell. That is, to perform the LTM procedure, the first base station 104a configures the UE 102 with one or more candidate cell configurations prior to transmitting the CSC 206 to the UE 102. As the UE 102 moves from the source cell 204a toward the candidate/target cell 204b, the UE 102 may send beam information to the first base station 104a, which may cause the first base station 104a to trigger activation of a configured candidate cell by transmitting the CSC 206 to the UE 102. The UE 102 receives the CSC 206 and determines which candidate cell configuration to apply/activate. The CSC 206 can carry beam indication and timing advance (TA) information to reduce the latency for switching from the source cell 204a to the candidate/target cell 204b.

The base station 104a and/or the UE 102 can implement machine learning (ML) model(s) for improving an overall system performance associated with LTM procedures. For example, the base station 104a and/or the UE 102 may use an ML model to predict a candidate/target cell 104b that the UE 102 is expected to switch to at a later point in time. The prediction may be indicated via the CSC 206 received by the UE 102. In some examples, the prediction is for a sequence of candidate/target cells associated with cell switches of the UE 102. For instance, the CSC 206 may trigger the UE 102 to switch to a first target cell upon receiving the CSC 206, switch to a second target cell 2 seconds after switching to the first target cell, and switch to a third target cell 10 seconds after switching to the second target cell. A CSC 206 implemented based on cell switching prediction(s) can conserve UE power by reducing a number of cell quality measurement instances, reduce overhead associated with triggering signals, and/or reduce time-frequency resource waste associated with sending a triggering signal and receiving corresponding feedback.

A TRP, such as the first base station 104a, the second base station 104b, or a network entity thereof, can be associated with or identified by a TRP identifier (ID). For example, the network entity/base station 104 may include or configure a TRP ID in configurations that the network entity/base station 104 transmits to the UE 102 for uplink or downlink transmissions via a TRP indicated by the TRP ID. The configurations may correspond to downlink control information (DCI) transmitted on a physical downlink control channel (PDCCH), a physical downlink shared channel (PDSCH) configuration, a physical uplink control channel (PUCCH) configuration, a physical uplink shared channel (PUSCH) configuration, and/or a channel state information (CSI) resource or SRS configuration included in a radio resource control (RRC) message (e.g., an RRC reconfiguration message or an RRC resume message) that the network entity/base station 104 transmits to the UE 102. Downlink transmissions may further include channel state information-reference signal (CSI-RS) transmissions and synchronization signal block (SSB) transmissions.

In other implementations, the network entity/base station 104 does not transmit/configure a TRP ID to the UE 102, but instead provides an implicit indication of the TRP to the UE 102. The implicit indication can be a configuration parameter, such as a control resource set (CORESET)PoolIndex, a value/candidate of the CORESETPoolIndex, a dataScramblingIdentityPDSCH, a dataScramblingIdentityPDSCH2, or a PUCCH-ResourceGroup. The UE 102 may determine a TRP (identifier) from the implicit indication. The network entity/base station 104 can also transmit, to the UE 102, an RRC message (e.g., an RRC reconfiguration message or an RRC resume message) including the configuration parameters.

The first base station 104a may configure or indicate, to the UE 102, a first TRP ID. Alternatively, the UE 102 may derive the first TRP ID/value from the implicit indication of the TRP. The first base station 104a may also configure or indicate, to the UE 102, a second TRP ID/value, or the UE 102 may derive the second TRP ID/value from the implicit indication. The UE 102 associates the first TRP ID with the first TRP and the second TRP ID with the second TRP.

The first base station 104a may configure the serving cell 204a as being associated with the first TRP or the first TRP ID/value and configure the target cell 204b as being associated with the second TRP or the second TRP ID/value. The first base station 104a may configure a first CORESET for the serving cell 204a or the first TRP (e.g., CORESETPoolIndex #0 may indicate the first CORESET). The first base station 104a transmits, to the UE 102, the RRC message (e.g., RRC setup message, RRC reconfiguration message, or RRC resume message) configuring the first CORESET and/or including the CORESETPoolIndex #0. Thus, the UE 102 monitors a PDCCH on the first CORESET to receive DCI from the first base station 104a, which may imply that the UE 102 monitors the PDCCH or receives the DCI via the first TRP. In such cases, the UE 102 determines that CORESETPoolIndex #0 indicates the first TRP.

The second TRP is associated with a non-serving cell, which the first base station 104a may indicate or configure in a second RRC message. The first base station 104a may configure the non-serving cell to be associated with the second TRP or the second TRP ID/value. The first base station 104 can further configure a second CORESET for the serving cell 204a, the non-serving cell, or the second TRP (e.g., CORESETPoolIndex #1 may indicate the second CORESET). The RRC message that the first base station 104a transmits to the UE 102 may configure the second CORESET and/or include the CORESETPoolIndex #1. Thus, the UE 102 monitors the PDCCH on the second CORESET to receive DCI, which may imply that the UE 102 monitors the PDCCH or receives the DCI via the second TRP. In such cases, the UE 102 determines that CORESETPoolIndex #1 indicates the second TRP.

The first base station 104a may configure the UE 102 with one or more candidate cell configurations including information for neighboring cells or non-serving cells of the UE 102. The one or more candidate cell configurations may include information for the candidate target cell 204b of the UE 102 for performing the LTM procedure. The candidate cell configuration may be indicated via an RRCReconfiguration message, a CellGroupConfig information element (IE), or a special (Sp)CellConfig IE. In some examples, the candidate cell is a currently configured/activated secondary cell (SCell) of the UE 102. The candidate cell configuration can include one or more of a candidate cell configuration ID, a physical cell ID (PCI) or a logical index of the PCI (e.g., PCI index), one or more transmission configuration indicator (TCI) state lists for the candidate cell, a configuration for downlink reference signals (e.g., SSB or CSI-RS) for measuring an L1-reference signal received power (L1-RSRP) and/or an L1-signal-to-interfernce plus noise ratio (L1-SINR) for/in the candidate cell, or a configuration for uplink reference signals (e.g., SRS) for measuring uplink CSI for/in the candidate cell.

The first base station 104a may indicate a PDCCH order to the UE 102. The PDCCH order may trigger the UE 102 to perform a random access (RA) procedure. The UE 102 may perform the RA procedure for acquiring the TA value and/or indicating the TA value. The first base station 104a transmits the PDCCH order for the TA value for the candidate target cell 204b. The first base station 104a can transmit the PDCCH order for the TA value for the candidate target cell 204b before transmitting the CSC 206 indicating the candidate target cell 204b. The first base station 104a can also transmit the PDCCH order for the TA value for the neighboring cell or a TRP in a neighboring cell.

The UE 102 transmits a PRACH based on information indicated via the PDCCH order. For the UE 102 to transmit the PRACH, the PDCCH order may indicate one or more of a random access preamble index, an uplink indicator or supplementary uplink indicator that indicates which uplink carrier in the serving cell 204a is for transmitting the PRACH, a synchronization signal/physical broadcast channel (SS/PBCH) index that indicates an SS/PBCH for the UE 102 to determine a random access channel (RACH) occasion for the PRACH transmission, or a PRACH mask index that indicates the RACH occasion associated with the SS/PBCH indicated by the SS/PBCH index for the PRACH transmission. While the CSC 206 illustrated in the diagram 200 may be for switching the UE 102 from the source cell 204a to the target cell 204b based on a current measurement or request (e.g., non-prediction-based/non-enhanced CSC), the CSC 206 may additionally or alternatively be implemented based on a cell switching prediction (e.g., prediction-based/enhanced CSC) of one or more future target cells, such as a next target cell and/or a sequence of target cells, to which the UE 102 is predicted to switch.

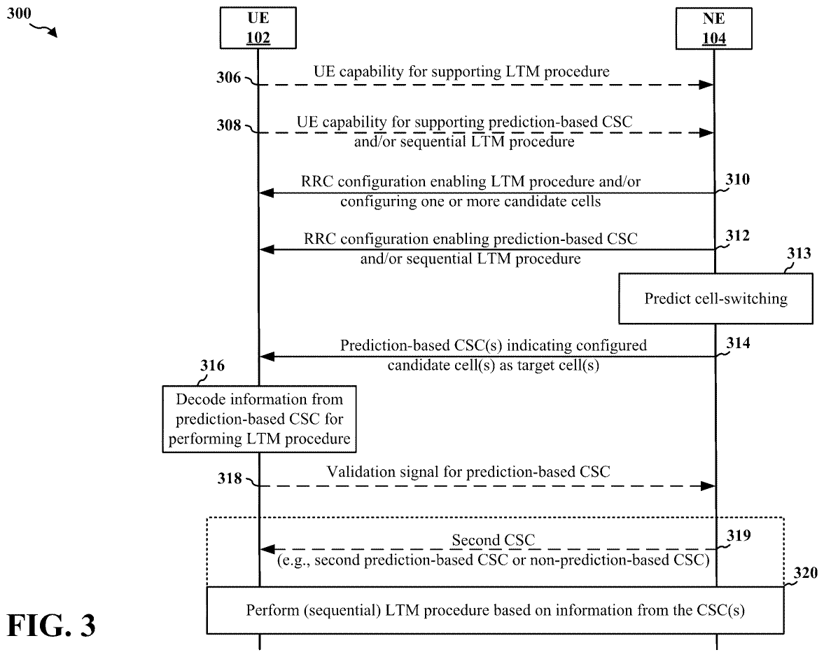

FIG. 3 illustrates a signaling diagram 300 for configuring and implementing a prediction-based CSC according to a cell-switching prediction 313 at the network entity 104. “Prediction-based CSC”, as used herein, can also be referred to as an enhanced CSC. The UE 102 reports/transmits 306, to the network entity 104, a UE capability for supporting an LTM procedure. The UE 102 may also report/transmit 308, to the network entity 104, a UE capability for supporting the prediction-based CSC and/or a sequential LTM procedure (e.g., based on the prediction-based CSC). In some examples, the UE 102 indicates the UE capability for the LTM procedure and the UE capability for the prediction-based CSC and/or the sequential LTM procedure in a same capability message (e.g., 306 and 308 may be included in a same message). In other examples, the UE 102 indicates the UE capability for the LTM procedure and the UE capability for the prediction-based CSC and/or the sequential LTM procedure in different capability messages. In still further examples, the first message that the UE 102 transmits 306 to the network entity 104 indicating support for the LTM procedure may also indicate support for the sequential LTM procedure, such that the second message indicating support for the prediction-based CSC may be transmitted 308 independently of the indication of support for the sequential LTM procedure.

The network entity 104 transmits 310, to the UE 102, an RRC configuration enabling the LTM procedure and/or configuring one or more candidate cells. The network entity 104 may also transmit 312, to the UE 102, an RRC configuration enabling functionality for the prediction-based CSC and/or the sequential LTM procedure. In some examples, the network entity 104 configures the LTM procedure and/or the one or more candidate cells in a same RRC message as the network entity 104 configures the prediction-based CSC and/or the sequential LTM procedure (e.g., 310 and 312 may be included in a same RRC message). In other examples, the network entity 104 configures the LTM procedure and/or the one or more candidate cells in a different RRC message from the RRC message used to configure the prediction-based CSC and/or the sequential LTM procedure. In still further examples, the first RRC message that the UE 102 transmits 310 to the network entity 104 enabling the LTM procedure may also enable the sequential LTM procedure, such that the second message enabling the prediction-based CSC may be transmitted 312 independently of configuring the sequential LTM procedure.

The network entity 104 can perform 313 a cell-switching prediction (e.g., based on an ML model) to predict a next target cell that the UE 102 is expected to switch to at a later time, which may, in some examples, include predicting 313 a plurality of target cells that the UE is expected to switch to in sequence. The network entity 104 transmits 314, to the UE 102 based on the prediction 313, prediction-based CSC(s) indicating configured candidate cell(s) as target cell(s). After receiving 314, the prediction-based CSC(s) from the network entity 104, the UE 102 decodes 316 information from the prediction-based CSC for performing 320 the LTM procedure. In some examples, the prediction-based CSC is received 314 by both the UE 102 and one or more other UEs (not shown).

The UE 102 may report/transmit 318, to the network entity 104, a validation signal for the prediction-based CSC. The validation signal confirms the cell-switching indicated via the prediction-based CSC. In some examples, the validation signal is hybrid automatic repeat request (HARQ) acknowledgment/negative acknowledgment (ACK/NACK) feedback for the prediction-based CSC that indicates whether the UE 102 successfully received 314 and decoded 316 the prediction-based CSC from the network entity 104. In other examples, the validation signal may provide ACK-only or NACK-only feedback to the network entity 104. The network entity 104 can configure whether the UE 102 is to report 318 the feedback for the prediction-based CSC. In some examples, the validation signal is ACK/NACK feedback, ACK-only feedback, or NACK-only feedback to indicate whether the indicated cell(s) in the predicted CSC satisfy the criteria for cell switching.

The UE 102 and the network entity 104 perform 320 the (sequential) LTM procedure based on information included in the CSC(s) received from the network entity 104. That is, if the CSC(s) are based on/include an indication of sequential candidate cell switches, the UE 102 and the network entity 104 perform 320 the LTM procedure based on the sequence information. Otherwise, the UE 102 and the network entity 104 perform 320 the LTM procedure based on information for a single cell switch of the UE 102.

Before performing 320 the LTM procedure or prior to completing a sequential LTM procedure, the UE 102 may receive 319 a second CSC from the network entity 104. The second CSC may be a non-prediction-based CSC (e.g., a legacy CSC or a Release 18 CSC) or a second prediction-based CSC, where the previously received/decoded CSC is a first CSC. If the LTM procedure is for a single cell switch of the UE 102 (e.g., the second CSC is received 319 before performing 320 the LTM procedure), the UE 102 may cancel the LTM procedure based on the first CSC and perform 320 the LTM procedure based on the second CSC. If the LTM procedure is for sequential cell switches (e.g., the second CSC is received 319 before or during performance 320 of the sequential LTM procedure), the UE 102 can either terminate the current and/or one or more remaining LTM procedures based on the first CSC to replace the terminated LTM procedure(s) with LTM procedure(s) based on the second CSC, or update the information to perform 320 the current and/or next LTM procedure based on the second CSC but still perform 320 remaining cell-switches in the sequence based on the first CSC.

The network entity 104 transmits 319, to the UE 102, the non-prediction-based CSC (i.e., a CSC that is not based on the cell switching prediction 313) via medium access control-control element (MAC-CE) or PDSCH. For example, the CSC may be a MAC-CE. In other implementations, the network entity 104 may transmit 319, to the UE 102, the non-prediction-based CSC via DCI. For example, the DCI can schedule a PDSCH that carries the non-prediction-based CSC. Both prediction-based CSCs and non-prediction-based CSCs may indicate a target cell or a candidate cell as well as a candidate cell configuration identifier. “Target cell” may be, or can refer to, a candidate cell indicated via the CSC and/or configured by the network entity 104.

After receiving the CSC, or after an action time of the CSC, the UE 102 performs 320 the LTM procedure with the network entity 104 based on the CSC. The UE 102 may determine the target cell and/or a corresponding candidate cell configuration based on a candidate cell configuration ID indicated in the CSC. After completion of the LTM procedure, the target cell indicated by the CSC may become a (next or current) physical serving cell/PCell. The UE 102 can then move from the source cell to the target cell, where the UE 102 can receive downlink data and/or transmit uplink data in the target cell. “Source cell” may be, or can refer to, an initial or previous physical serving cell/PCell of the UE 102 prior to receiving the CSC and completing LTM procedure.

The CSC may include one or more fields or information, such as information for identifying target cells (e.g., a candidate cell configuration index), TA-related information, a beam indication for the target cell, active downlink/uplink bandwidth parts (BWPs) for the candidate/target cell, etc. The beam indication may be a joint unified TCI state/index or a pair of uplink and downlink unified TCI states/indexes. In further examples, the CSC indicates triggering information, such as instructions to trigger an aperiodic tracking reference signal (TRS) transmitted from the target cell, where the aperiodic TRS may be quasi-co-located (QCLed) with a downlink reference signal configured in beam indication signaling for the target cell, if the beam indication signaling for the target cell is included in the CSC. In some examples, the TRS is a CSI-RS among a CSI-RS resource set for tracking, e.g., a CSI-RS resource set configured with an RRC parameter TRSInfo. Other triggering information can include instructions to trigger CSI acquisition of the target cell and a corresponding report for the target cell, instructions to trigger an aperiodic CSI-RS for pathloss measurement for uplink power control where the aperiodic CSI-RS may be QCLed with a downlink reference signal configured in the beam indication signaling for the target cell if the beam indication signaling for the target cell is included in the CSC, instructions to trigger an aperiodic SRS transmission for the target cell, and/or a cell-radio network temporary identifier (C-RNTI).

The network entity 104 may transmit 314, to the UE 102, the prediction-based CSC via MAC-CE or PDSCH, or the network entity 104 may indicate, to the UE 102, the prediction-based CSC via DCI, which may not schedule a downlink assignment or an uplink grant. The UE 102 may receive a second DCI from the network entity 104 if the prediction-based CSC is a MAC-CE or PDSCH. The second DCI may schedule a PDSCH carrying the prediction-based CSC. In some examples, for performing 320 the LTM procedure, the prediction-based CSC carries or indicates one or more sets of LTM information, each of which may trigger an LTM procedure to switch the UE 102 to candidate cells. The network entity 104 transmits, to the UE 102, the one or more sets of LTM information for triggering/performing 320 LTM procedure. For instance, the network entity 104 may indicate the one or more candidate cell(s)/target cell(s) for UE switching, where each of the indicated candidate cell(s)/target cell(s) may be switched to in a sequential order.

Information or fields used for triggering/performing 320 the LTM procedure may include or indicate a switching order/index for the candidate cells(s). However, the switching order/index may be disregarded by the UE 102 (e.g., for non-prediction-based LTM) or absent from the prediction-based CSC when the UE 102 and the network entity 104 are to perform 320 one LTM procedure based on the decoded 316 information from the prediction-based CSC. The information or fields may include or indicate whether the LTM procedure is associated with a cell-switching prediction 313. The CSC may also indicate whether a validation procedure is to be performed for the indicated cell(s) of the LTM procedure. In other examples, the CSC may indicate a type of the LTM procedure, such as a Type 1 LTM procedure that is not based on a candidate cell prediction 313 or a Type 2 LTM procedure that is based on a candidate cell prediction 313. The information or fields may include or indicate TA-related information to be applied for the target cell (e.g., a TA command or information to determine a TA value), timing information for each indicated target cell (e.g., an action time, an action delay, or a dwelling/applied time for each indicated candidate cell), and/or information to determine a PUCCH resource for ACK/NACK feedback. The timing information octet/field may be disregarded by the UE 102 for non-prediction-based LTM procedures. In still further examples, the prediction-based CSC can indicate a candidate cell ID, a beam indication, active downlink/uplink BWPs, and/or instructions to trigger aperiodic TRS/CSI-RS for CSI acquisition/SRS, similar to non-prediction-based CSC techniques.

In some implementations, the network entity 104 transmits 314 a single signal using one prediction-based CSC that indicates the LTM information, e.g., for a sequence of LTM procedures. In other implementations, the network entity 104 transmits 314 separate signals that respectively indicate the LTM information, e.g., for the sequence of LTM procedures. The network entity 104 may transmit the LTM information via one or more MAC-CEs (e.g., one or more the prediction-based CSCs or alternatively one or more non-prediction-based CSCs). The network entity 104 can transmit the LTM information in a single PDSCH or within a single time interval (e.g., a time slot or a set of symbols), e.g., regardless of whether the network entity 104 transmits the LTM information via a single signal or separate signals.

Timing related information associated with the LTM procedure(s) may or may not correspond to TA related information. For example, the timing related information may indicate to the UE 102 when to switch to, or when to measure, an indicated candidate cell. The timing related information may indicate a predicted length of time for maintaining the indicated candidate cell or a predicted length of time for applying a candidate cell configuration for the indicated candidate cell.

The timing related information may correspond to a time delay. The time delay for the LTM information may be applied for the indicated candidate cell. The LTM information for the candidate cell may be applied starting from a corresponding action time. The action time for the LTM information may be a time interval (e.g., a slot or a symbol) that occurs after the time delay. The UE 102 may perform 320 the LTM procedure for the candidate cell indicated via the LTM information starting from the action time of the LTM information or starting after the time delay indicated via the LTM information. In some examples, the time delay may start after X1 symbol(s) (or slot(s) or ms) from the UE 102 receiving on a first or last symbol of a PDCCH or PDSCH associated with the prediction-based CSC, where XI may be predefined (e.g., 0), reported 308 by the UE 102 via the UE capability report, configured 312 by the network entity 104 via higher layer signaling (e.g., RRC signaling), or indicated by the network entity 104 via a MAC-CE or DCI. In other examples, the time delay starts after X2 symbol(s) (or slot(s) or ms) from the UE 102 transmitting on the first or last symbol of the PUSCH or PUCCH associated with an ACK for the prediction-based CSC or the LTM information, where X2 may be predefined (e.g., 0), reported 308 by the UE 102 via the UE capability report, configured 312 by the network entity 104 via higher layer signaling (e.g., RRC signaling), or indicated by the network entity 104 via MAC-CE or DCI. The network entity 104 may or may not indicate via the CSC a time delay for the candidate cell to be switched or the candidate cell with a lowest switch order value in the corresponding LTM information. In still further examples, the time delay may start at or after a slot or symbol where the cell-switching prediction is transmitted to the UE 102, or at or after a slot or symbol where corresponding ACK/NACK feedback is transmitted to the network entity 104.

The timing related information can also indicate an absolute timing. The LTM information for the candidate cell may be applied starting from the absolute timing indicated via the LTM information. The UE 102 may perform 320 the LTM procedure for the candidate cell based on the absolute time. The absolute timing may correspond to a symbol, slot, subframe, or frame index. The network entity 104 may or may not indicate via the CSC the absolute timing for the candidate cell to be switched or the candidate cell with the lowest switch order value in the corresponding LTM information.

In further implementations, the timing related information indicates a predicted dwelling/applied time for a cell. The timing related information for the predicted dwelling/applied time for the candidate cell can be indicated in the LTM information. The UE 102 may start to perform 320 the LTM procedure for switching to a next candidate cell when the dwelling/applied time for a current source/serving cell has ended or is approaching an end. The UE 102 performs a reference signal measurement for downlink synchronization for the next candidate cell when the dwelling/applied time for the current source/serving cell has ended or is approaching an end.

The UE 102 may perform 320 the LTM procedure for switching to a candidate cell, such as a candidate cell with the lowest switching order value associated with the prediction-based CSC(s), after a last symbol/slot of a PDCCH/PDSCH carrying the prediction-based CSC(s) or after a last symbol/slot of uplink resources for reporting hybrid automatic repeat request-acknowledgment (HARQ-ACK) feedback for a PDCCH/PDSCH carrying the prediction-based CSC(s). A next switching of the cell may be to a candidate cell with a switching order value higher and closest to the switching order value of the current serving/source cell. The switching order value of the current source/serving cell before the UE 102 receives 314 the prediction-based CSC may be assumed by the UE 102 as the lowest value or value 0.

The UE 102 may transmit 318 a validation signal to the network entity 104, after the network entity 104 transmits 314 the PDCCH/PDSCH with the prediction-based CSC carrying the LTM information. The PDSCH can include multiple prediction-based CSCs that each indicate LTM information. The network entity 104 may configure or indicate to the UE 102 whether to transmit 318 the validation signal for the LTM information or whether to report/transmit prediction-based CSC information to the network entity 104. The validation signal may indicate whether the UE 102 supports some or all of the LTM information indicated in the prediction-based CSC. The validation signal may be associated with a bitmap, where each bit in the bitmap corresponds to a portion of the LTM information. Each bit may indicate whether the UE 102 supports the corresponding LTM information. A bit-length of the bitmap may be based on an amount of LTM information indicated via the prediction-based CSC. In further examples, the validation signal can indicate whether the UE 102 detects or determines that cell-switching criteria is satisfied for the LTM information indicated via the prediction-based CSC.

The validation signal may indicate whether the UE 102 detects or determines that a criterion is satisfied or met for switching to a next candidate cell indicated by the LTM information. The criterion to switch to the next candidate cell may be that a first beam quality (e.g., a layer 1 reference signal received power (L1-RSRP) or layer 1 signal-to-interference plus noise ratio (L1-SINR)) for the next candidate cell is higher than a second beam quality for a current serving cell plus a first threshold, where the first threshold may be predefined or configured by the network entity 104 via RRC signaling or MAC-CE. In further examples, the criterion to switch to the next candidate cell may be that the second beam quality for the current serving cell is lower than a second threshold, where the second threshold may be predefined or configured by the network entity 104 via RRC signaling or MAC-CE. In some implementations, the UE 102 transmits 318 the validation signal to the network entity 104 if the cell-switching criterion is satisfied (e.g., ACK-only). In other implementations, the UE 102 transmits 318 the validation signal to the network entity 104 if the cell-switching criteria is not satisfied (e.g., NACK-only). Accordingly, the validation signal indicates whether the cell-switching criteria is satisfied.

The validation signal may be a one-bit signal or an uplink resource in implementations where the validation signal indicates whether the UE 102 supports all of the LTM information. The validation signal may have a positive sign or the network entity 104 may detect/receive the validation signal if the UE 102 supports the LTM information, whereas the validation signal may have a negative sign or the network entity 104 may not detect/not receive the validation signal if the UE 102 does not support at least a portion of the LTM information. The UE 102 transmits 318 the validation signal to the network entity 104 via a PUCCH resource, a PUSCH resource (e.g., which may be based on a dynamic or configured uplink grant), a PRACH resource, or a message A (Msg A). The resource for the validation signal may be indicated via the LTM information, configured by RRC signaling, or indicated by DCI. If the UE 102 does not support the LTM information indicated by the prediction-based CSC, the UE 102 and/or the network entity 104 may not perform the LTM procedure for the corresponding candidate cell.

In some implementations, the UE 102 refrains from verifying the switching to the first candidate cell indicated via the prediction-based CSC or the candidate cell with the lowest switching order value in the corresponding LTM information. For example, the UE 102 may refrain from transmitting the validation signal to the network entity 104 if the network entity 104 only indicates via the prediction-based CSC one candidate cell to be switched. If the network entity 104 receives/detects the validation signal when only one candidate cell is indicated, the network entity 104 may determine that the reception/detection of the validation signal is an error and may disregard the validation signal.

The network entity 104 may notify the UE 102 to update the LTM information indicated by the prediction-based CSC after transmitting 314 the prediction-based CSC to the UE 102, such as by updating one or more fields in the LTM information. For example, the network entity 104 may update a beam indication or TA related information. The network entity 104 can also transmit 319 a subsequent CSC to update the LTM information indicated by a prior CSC (e.g., the prediction-based CSC). The network entity 104 can indicate to the UE 102 which portion(s) of the LTM information to update by indicating same/different switching order value(s) for the LTM information.

During a time duration that starts at the network entity 104 transmitting 314 the prediction-based CSC and ends at completion of the LTM procedure for a last candidate cell to be switched or at completion of the LTM procedure for the candidate cell with the largest switch order value, the network entity 104 may transmit 319 a non-prediction-based CSC to the UE 102, which may indicate that the UE 102 is to cancel or not perform the current/ongoing LTM procedure and/or the LTM procedure(s) for one or more next/remaining candidate cell(s) indicated via the prediction-based CSC. Instead, the UE 102 performs 320 the LTM procedure for the candidate cell based on the non-prediction-based CSC. In other examples, the non-prediction-based CSC indicates that the UE 102 is to cancel or not perform the current/ongoing LTM procedure and/or the LTM procedure for the next candidate cell indicated in the prediction-based CSC, but to still perform 320 the LTM procedure for remaining candidate cell(s) indicated in the prediction-based CSC.

After performing/completing the LTM procedure for the candidate cell indicated in the non-prediction-based CSC the UE 102 may still perform LTM procedure(s) for other candidate cells indicated in prediction-based CSC(s) based on corresponding timing related information. For example, the UE 102 may switch to the next candidate cell based on candidate cell configuration index 1 and switching order value 2 indicated in the non-prediction-based CSC, whereas the UE 102 may switch to other candidate cell(s) based on candidate cell configuration index 5 and switching order value 3, and candidate cell configuration index 9 and switching order value 4 indicated in the prediction-based CSC. If the network entity 104 transmits a non-prediction-based CSC to the UE 102 indicating a candidate cell with candidate cell configuration index 2, the UE may perform the LTM procedure for candidate cell configuration index 2. After performing/completing the LTM procedure for the candidate cell with candidate cell configuration index 2, the UE 102 may still perform LTM procedure(s) for candidate cells with candidate cell configuration indexes 5 and 9 based on the corresponding timing related information.

In further implementations, the non-prediction-based CSC may update fields indicated by a prior CSC for the current/ongoing LTM procedure and/or for switching to the next candidate cell. In such implementations, the network entity 104 may confirm that the candidate cell indicated by the non-prediction-based CSC is the same as the next candidate cell indicated in the prediction-based CSC. If the prediction-based CSC carried in a PDSCH or transmitted in a slot only indicates LTM information and no other prediction-based CSC is transmitted by the network entity 104 in the same PDSCH or the same slot, the UE 102 may treat the prediction-based CSC as a non-prediction-based CSC, which may imply that the network entity and/or UE procedure for the prediction-based CSC is the same as for the non-prediction-based CSC.

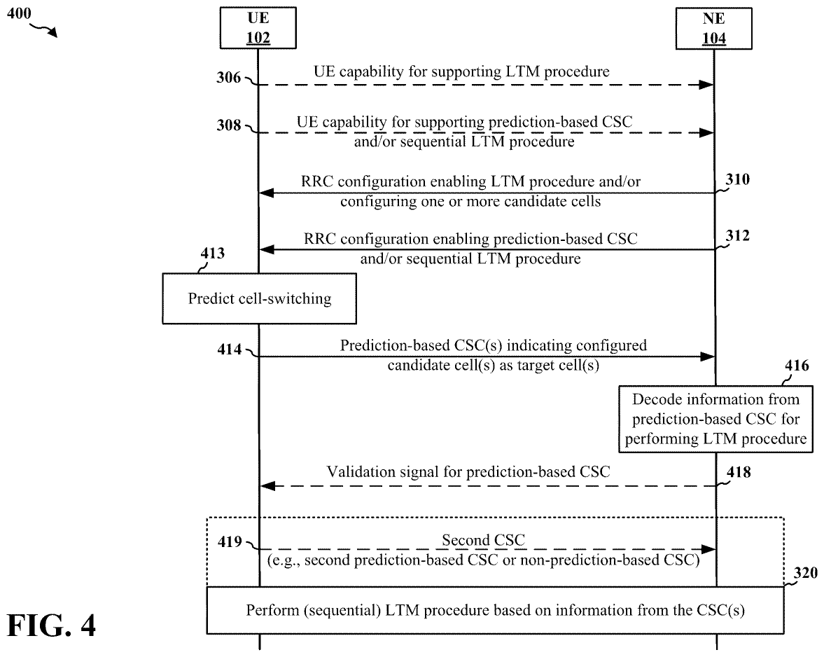

FIG. 4 illustrates a signaling diagram 400 for configuring and implementing a prediction-based CSC according to a cell-switching prediction 413 at the UE 102. Elements 306, 308, 310, 312, and 320 have already been described with respect to FIG. 3.

Elements 413, 414, 416, 418 and 419 are similar to elements 313, 314, 316, 318 and 319, and may include the same or similar functionalities as described with respect to FIG. 3, albeit in reverse directions or at reversed nodes as described with respect to FIG. 3. For example, the UE 102 performs 413 the cell-switching prediction (e.g., based on an ML model) to predict a next target cell that the UE 102 is expected to switch to at a later time, which may, in some examples, include predicting 413 a plurality of target cells that the UE is expected to switch to in sequence. The UE 102 transmits 414, to the network entity 104 based on the prediction 413, prediction-based CSC(s) indicating configured candidate cell(s) as target cell(s). In some examples, the prediction-based CSC(s) may also be referred to as prediction-based cell switching report(s) or prediction-based cell switching request(s). After receiving 414, the prediction-based CSC(s) from the UE 102, the network entity 104 decodes 416 information from the prediction-based CSC for performing 320 the LTM procedure.

The network entity 104 may report/transmit 418, to the UE 102, a validation signal for the prediction-based CSC. The validation signal confirms the cell-switching indicated via the prediction-based CSC. The UE 102 and the network entity 104 perform 320 the (sequential) LTM procedure based on information included in the CSC(s) transmitted to the network entity 104. That is, if the CSC(s) are based on/include an indication of sequential candidate cell switches, the UE 102 and the network entity 104 perform 320 the LTM procedure based on the sequence information. Otherwise, the UE 102 and the network entity 104 perform 320 the LTM procedure based on information for a single cell switch of the UE 102.

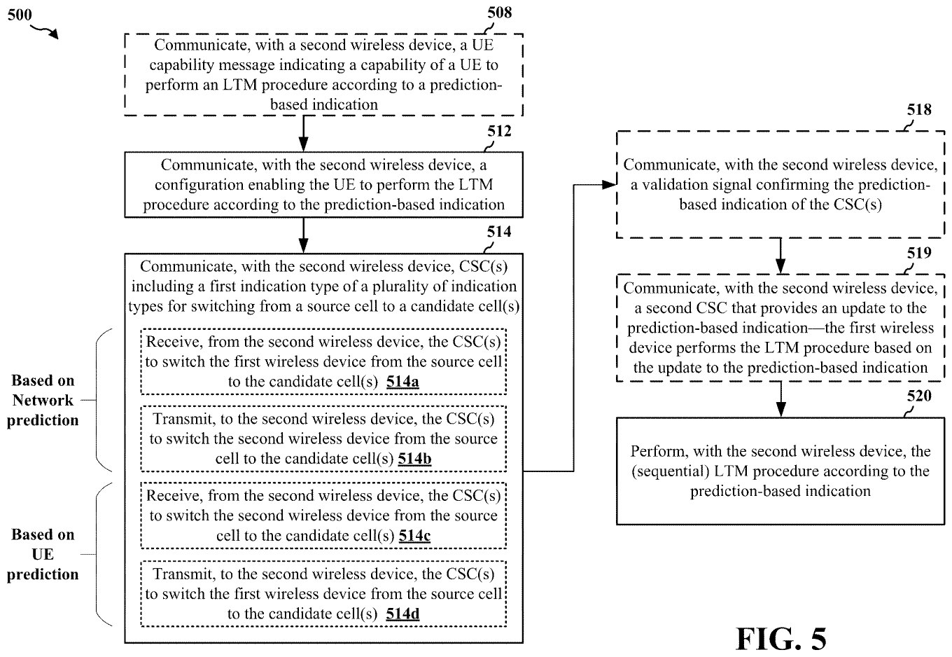

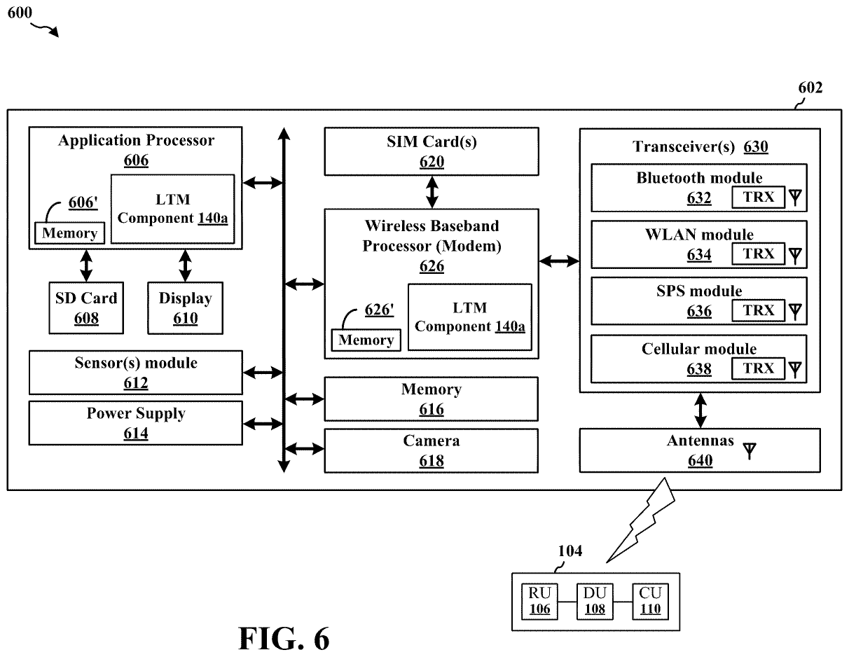

Before performing 320 the LTM procedure or prior to completing a sequential LTM procedure, the UE 102 may transmit 419 a second CSC to the network entity 104. The second CSC may be a non-prediction-based CSC or a second prediction-based CSC, where the previously transmitted CSC is a first prediction-based CSC. If the LTM procedure is for a single cell switch of the UE 102 (e.g., the second CSC is transmitted 419 before performing 320 the LTM procedure), the network entity 104 may cancel the LTM procedure based on the first CSC and perform 320 the LTM procedure based on the second CSC. If the LTM procedure is for sequential cell switches (e.g., the second CSC is transmitted 419 before or during performance 320 of the sequential LTM procedure), the network entity 104 can either terminate the current and/or one or more remaining LTM procedures based on the first CSC to replace the terminated LTM procedure(s) with LTM procedure(s) based on the second CSC, or update the information to perform 320 the current and/or next LTM procedure based on the second CSC but still perform 320 remaining LTM procedures in the sequence based on the first CSC. FIGS. 3-4 illustrate cell-switching predictions. FIGS. 5-6 show methods for implementing one or more aspects of FIGS. 3-4. In particular, FIG. 5 shows an implementation by a first wireless device of the one or more aspects of FIGS. 3-4. FIG. 6 shows an implementation by a second wireless device of the one or more aspects of FIGS. 3-4.

FIG. 5 illustrates a flowchart 500 of a method of wireless communication at a first wireless device. With reference to FIGS. 3-4 and 6-7, the method may be performed by the first wireless device, which may be the UE 102, the UE apparatus 602, or one or more network entities 104. The UE apparatus 602 may include the memory 626′, 606′, 616, which may correspond to the entire UE 102 or the entire UE apparatus 602, or a component of the UE 102 or the UE apparatus 602, such as the wireless baseband processor 626 and/or the application processor 606. The one or more network entities 104 may correspond to a base station or a unit of the base station, such as the RU 106, the DU 108, the CU 110, an RU processor 706, a DU processor 726, a CU processor 746, etc. The one or more network entities 104 may include memory 706′/726′/746′, which may correspond to an entirety of the one or more network entities 104, or a component of the one or more network entities 104, such as the RU processor 706, the DU processor 726, or the CU processor 746.

The first wireless device communicates 508, with a second wireless device, a UE capability message indicating a capability of a UE to perform an LTM procedure according to a prediction-based indication. For example, referring to FIGS. 3-4, the first wireless device (e.g., the UE 102) transmits 308, to the second wireless device (e.g., the network entity 104), a UE capability for supporting a prediction-based CSC and/or sequential LTM procedure. In other examples, the first wireless device (e.g., the network entity 104) receives 308, from the second wireless device (e.g., the UE 102), a capability for supporting a prediction-based CSC and/or sequential LTM procedure.

The first wireless device communicates 512, with the second wireless device, a configuration enabling the UE to perform the LTM procedure according to the prediction-based indication. For example, referring to FIGS. 3-4, the first wireless device (e.g., the UE 102) receives 312, from the second wireless device (e.g., the network entity 104), an RRC configuration enabling the prediction-based CSC and/or the sequential LTM procedure. In other examples, the first wireless device (e.g., the network entity 104) transmits 312, to the second wireless device (e.g., the UE 102), an RRC configuration enabling the prediction-based CSC and/or the sequential LTM procedure.

The first wireless device communicates 514, with the second wireless device, CSC(s) including a first indication type of a plurality of indication types, the first indication type for switching from a source cell to a candidate cell(s). In some examples, the first indication type includes a prediction-based indication for switching from a source cell to candidate cell(s). In other examples, the first indication type includes a sequential LTM procedure indication (e.g., sequential candidate cell switches). In still other examples, the first indication type includes a combination of a prediction-based indication and a sequential LTM procedure indication. For example, referring to FIGS. 3-4, the UE 102 and the network entity 104 communicate prediction-based CSC(s) indicating configured candidate cell(s) as target cell(s). Based on a network-side cell-switching prediction 313, the first wireless device (e.g., the UE 102) may receive 514a, from the second wireless device (e.g., the network entity 104), the CSC(s) to switch the first wireless device (e.g., the UE 102) from the source cell to the candidate cell(s). In some examples, the first wireless device (e.g., the network entity 104) may transmit 514b, to the second wireless device (e.g., the UE 102), the CSC(s) to switch the second wireless device (e.g., the UE 102) from the source cell to the candidate cell(s). Based on a UE-side cell-switching prediction 413, the first wireless device (e.g., the network entity 104) may receive 514c, from the second wireless device (e.g., the UE 102), the CSC(s) to switch the second wireless device (e.g., the UE 102) from the source cell to the candidate cell(s). In some examples, the first wireless device (e.g., the UE 102) may transmit 514d, to the second wireless device (e.g., the network entity 104), the CSC(s) to switch the first wireless device (e.g., the UE 102) from the source cell to the candidate cell(s).

The first wireless device communicates 518, with the second wireless device, a validation signal confirming the prediction-based indication of the CSC(s). For example, referring to FIG. 3, the first wireless device (e.g., the UE 102) transmits 318, to the second wireless device (e.g., the network entity 104), a validation signal for the prediction-based CSC(s). In other examples, the first wireless device (e.g., the network entity 104) receives 318, from the second wireless device (e.g., the UE 102), a validation signal for the prediction-based CSC(s). In some examples, referring to FIG. 4, the first wireless device (e.g., the network entity 104) transmits 418, to the second wireless device (e.g., the UE 102), a validation signal for the prediction-based CSC(s). In other examples, the first wireless device (e.g., the UE 102) receives 418, from the second wireless device (e.g., the network entity 104), a validation signal for the prediction-based CSC(s).

The first wireless device communicates 519, with the second wireless device, a second CSC that provides an update to the prediction-based indication-the first wireless device performs the LTM procedure based on the update to the prediction-based indication. For example, referring to FIG. 3, the first wireless device (e.g., the UE 102) receives 319, from the second wireless device (e.g., the network entity 104), a second CSC, which may be a second prediction-based CSC or a non-prediction-based CSC, for performing 320 an (updated) LTM procedure. In other examples, the first wireless device (e.g., the network entity 104) transmits 319, to the second wireless device (e.g., the UE 102), a second CSC, which may be a second prediction-based CSC or a non-prediction-based CSC, for performing 320 an (updated) LTM procedure. In some examples, referring to FIG. 4, the first wireless device (e.g., the UE 102) transmits 419, to the second wireless device (e.g., the network entity 104), a second CSC, which may be a second prediction-based CSC or a non-prediction-based CSC, for performing 320 an (updated) LTM procedure. In other examples, the first wireless device (e.g., the network entity 104) receives 419, from the second wireless device (e.g., the UE 102), a second CSC, which may be a second prediction-based CSC or a non-prediction-based CSC, for performing 320 an (updated) LTM procedure.

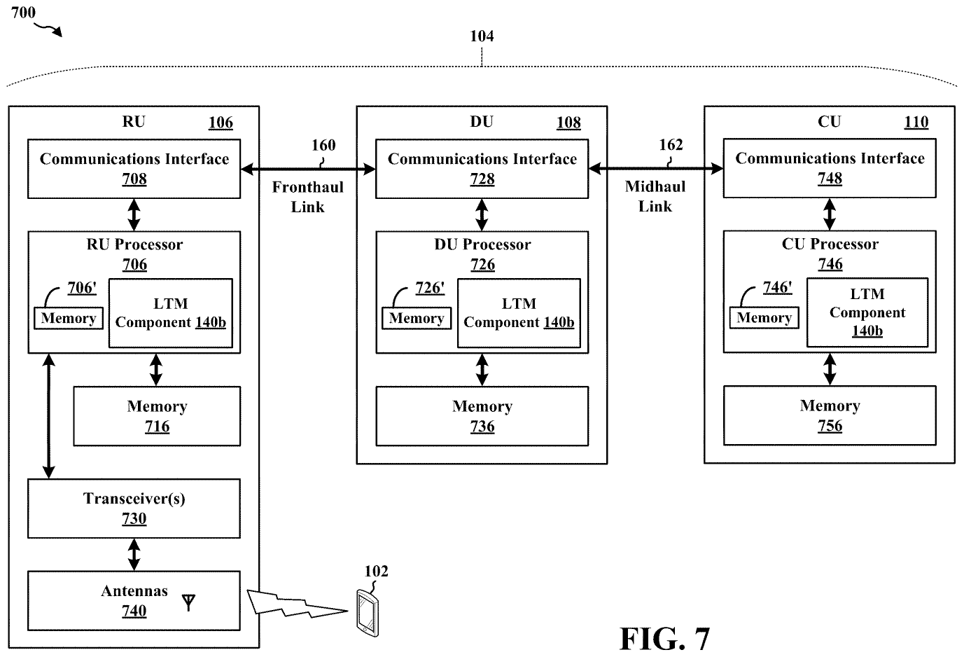

The first wireless device performs 520, with the second wireless device, the (sequential) LTM procedure according to the prediction-based indication. For example, referring to FIGS. 3-4, the first wireless device (e.g., the UE 102) performs 320 the (sequential) LTM procedure with the second wireless device (e.g., the network entity 104) based on information from the CSC(s). In other examples, the first wireless device (e.g., the network entity 104) performs 320 the (sequential) LTM procedure with the second wireless device (e.g., the UE 102) based on information from the CSC(s). A UE apparatus 602, as described in FIG. 6, may perform the method of flowchart 500. The one or more network entities 104, as described in FIG. 7, may also perform the method of flowchart 500.

FIG. 6 is a diagram 600 illustrating an example of a hardware implementation for a UE apparatus 602. The UE apparatus 602 may be the UE 102, a component of the UE 102, or may implement UE functionality. The UE apparatus 602 may include an application processor 606, which may have on-chip memory 606′. In examples, the application processor 606 may be coupled to a secure digital (SD) card 608 and/or a display 610. The application processor 606 may also be coupled to a sensor(s) module 612, a power supply 614, an additional module of memory 616, a camera 618, and/or other related components. For example, the sensor(s) module 612 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 602 may further include a wireless baseband processor 626, which may be referred to as a modem. The wireless baseband processor 626 may have on-chip memory 626′. Along with, and similar to, the application processor 606, the wireless baseband processor 626 may also be coupled to the sensor(s) module 612, the power supply 614, the additional module of memory 616, the camera 618, and/or other related components. The wireless baseband processor 626 may be additionally coupled to one or more subscriber identity module (SIM) card(s) 620 and/or one or more transceivers 630 (e.g., wireless RF transceivers).

Within the one or more transceivers 630, the UE apparatus 602 may include a Bluetooth module 632, a WLAN module 634, an SPS module 636 (e.g., GNSS module), and/or a cellular module 638. The Bluetooth module 632, the WLAN module 634, the SPS module 636, and the cellular module 638 may each include an on-chip transceiver (TRX), or in some cases, just a transmitter (TX) or just a receiver (RX). The Bluetooth module 632, the WLAN module 634, the SPS module 636, and the cellular module 638 may each include dedicated antennas and/or utilize antennas 640 for communication with one or more other nodes. For example, the UE apparatus 602 can communicate through the transceiver(s) 630 via the antennas 640 with another UE (e.g., sidelink communication) and/or with a network entity 104 (e.g., uplink/downlink communication), where the network entity 104 may correspond to a base station or a unit of the base station, such as the RU 106, the DU 108, or the CU 110 The wireless baseband processor 626 and the application processor 606 may each include a computer-readable medium/memory 626′, 606′, respectively. The additional module of memory 616 may also be considered a computer-readable medium/memory. Each computer-readable medium/memory 626′, 606′, 616 may be non-transitory. The wireless baseband processor 626 and the application processor 606 may each be responsible for general processing, including execution of software stored on the computer-readable medium/memory 626′, 606′, 616. The software, when executed by the wireless baseband processor 626/application processor 606, causes the wireless baseband processor 626/application processor 606 to perform the various functions described herein. The computer-readable medium/memory may also be used for storing data that is manipulated by the wireless baseband processor 626/application processor 606 when executing the software. The wireless baseband processor 626/application processor 606 may be a component of the UE 102. The UE apparatus 602 may be a processor chip (e.g., modem and/or application) and include just the wireless baseband processor 626 and/or the application processor 606. In other examples, the UE apparatus 602 may be the entire UE 102 and include the additional modules of the apparatus 602.

As discussed in FIG. 1 and implemented with respect to FIG. 5, the LTM component 140a is configured to: communicate, with a second wireless device, a CSC including a first indication type of a plurality of indication types, the first indication type for switching from a source cell to a candidate cell; and perform, with the second wireless device, an LTM procedure according to the first indication type. The LTM component 140a may be within the application processor 606, the wireless baseband processor 626, or both the application processor 606 and the wireless baseband processor 626. The LTM component 140a may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 7 is a diagram 700 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 746, which may have on-chip memory 746′. In some aspects, the CU 110 may further include an additional module of memory 756 and/or a communications interface 748, both of which may be coupled to the CU processor 746. The CU 110 can communicate with the DU 108 through a midhaul link 162, such as an F1 interface between the communications interface 748 of the CU 110 and a communications interface 728 of the DU 108.

The DU 108 may include a DU processor 726, which may have on-chip memory 726′. In some aspects, the DU 108 may further include an additional module of memory 736 and/or the communications interface 728, both of which may be coupled to the DU processor 726. The DU 108 can communicate with the RU 106 through a fronthaul link 160 between the communications interface 728 of the DU 108 and a communications interface 708 of the RU 106.

The RU 106 may include an RU processor 706, which may have on-chip memory 706′. In some aspects, the RU 106 may further include an additional module of memory 716, the communications interface 708, and one or more transceivers 730, all of which may be coupled to the RU processor 706. The RU 106 may further include antennas 740, which may be coupled to the one or more transceivers 730, such that the RU 106 can communicate through the one or more transceivers 730 via the antennas 740 with the UE 102.

The on-chip memory 706′, 726′, 746′ and the additional modules of memory 716, 736, 756 may each be considered a computer-readable medium/memory. Each computer-readable medium/memory may be non-transitory. Each of the processors 706, 726, 746 is responsible for general processing, including execution of software stored on the computer-readable medium/memory. The software, when executed by the corresponding processor(s) 706, 726, 746 causes the processor(s) 706, 726, 746 to perform the various functions described herein. The computer-readable medium / memory may also be used for storing data that is manipulated by the processor(s) 706, 726, 746 when executing the software. In examples, the LTM component 140b may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 5, the LTM component 140b is configured to: communicate, with a second wireless device, a CSC including a first indication type of a plurality of indication types, the first indication type for switching from a source cell to a candidate cell; and perform, with the second wireless device, an LTM procedure according to the first indication type. The LTM component 140b may be within one or more processors of the one or more network entities 104, such as the RU processor 706, the DU processor 726, and/or the CU processor 746. The LTM component 140b may be one or more hardware components specifically configured to carry out the stated processes/algorithm, implemented by one or more processors 706, 726, 746 configured to perform the stated processes/algorithm, stored within a computer-readable medium for implementation by the one or more processors 706, 726, 746, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a first wireless device, including: communicating, with a second wireless device, a CSC including a first indication type of a plurality of indication types, the first indication type for switching from a source cell to a candidate cell; and performing, with the second wireless device, an LTM procedure according to the first indication type.

Example 2 may be combined with Example 1 and includes that the first indication type includes a prediction-based indication and a second indication type of the plurality of indication types includes a non-prediction-based indication.

Example 3 may be combined with any of Examples 1-2 and includes that the communicating the CSC, further includes: receiving, from the second wireless device, the CSC to switch the first wireless device from the source cell to the candidate cell.

Example 4 may be combined with any of Examples 1-2 and includes that the communicating the CSC, further includes: transmitting, to the second wireless device, the CSC to switch the second wireless device from the source cell to the candidate cell.

Example 5 may be combined with any of Examples 1-2 and includes that the communicating the CSC, further includes: transmitting, to the second wireless device, the CSC to switch the first wireless device from the source cell to the candidate cell.

Example 6 may be combined with any of Examples 1-2 and includes that the communicating the CSC, further includes: receiving, from the second wireless device, the CSC to switch the second wireless device from the source cell to the candidate cell.

Example 7 may be combined with any of Examples 1-6 and includes that the first indication type is associated with a sequence of LTM procedures for the switching from the source cell to a plurality of candidate cells in sequence, and includes that the sequence of LTM procedures includes the LTM procedure, and includes that the plurality of candidate cells includes the candidate cell.

Example 8 may be combined with Example 7 and includes that the CSC triggers the sequence of LTM procedures based on a plurality of candidate cell configuration IDs for the plurality of candidate cells being included in the CSC.

Example 9 may be combined with Example 7 and includes that the CSC is one of a plurality of CSCs, and further includes: communicating, with the second wireless device, the plurality of CSCs on a same physical shared channel, each CSC of the plurality of CSCs including a respective first indication type to trigger the sequence of LTM procedures.

Example 10 may be combined with any of Examples 1-9 and includes that the CSC includes at least one of: an indicator of whether the LTM procedure is prediction-based, a cell-switching order, a cell-switching index, timing information for one or more cell switches, candidate cell identifier information, TA information, beam indication information for the candidate cell, or an active BWP identifier for the candidate cell.

Example 11 may be combined with Example 10 and includes that the timing information for the one or more cell switches indicates at least one of: a time delay, an absolute time, or a predicted time for application of the one or more cell switches.

Example 12 may be combined with any of Examples 1-11 and further includes: communicating, with the second wireless device, a validation signal confirming the first indication type in the CSC.

Example 13 may be combined with any of Examples 1-12 and further includes: communicating, with the second wireless device, a second CSC that provides an update to the first indication type, the performing the LTM procedure being based on the update to the first indication type.

Example 14 may be combined with Example 13 and includes that the second CSC includes a prediction-based indication or a non-prediction-based indication for the switching from the source cell to the candidate cell.

Example 15 may be combined with any of Examples 1-14 and further includes: communicating, with the second wireless device, a UE capability message indicating a capability of the UE for the performing the LTM procedure according to the first indication type.

Example 16 may be combined with any of Examples 1-15 and further includes: communicating, with the second wireless device, a configuration enabling the UE to perform the LTM procedure according to the first indication type.

Example 17 may be combined with any of Examples 1-3, 5, or 7-16 and includes that the first wireless device is a UE and the second wireless device is a network entity.

Example 18 may be combined with any of Examples 1-2, 4, or 6-16 and includes that the first wireless device is a network entity and the second wireless device is a UE.

Example 19 is an apparatus for wireless communication for implementing a method as in any of Examples 1-18.

Example 20 is an apparatus for wireless communication including means for implementing a method as in any of Examples 1-18.

Example 21 is a non-transitory computer-readable medium storing computer executable code, the code when executed by a processor causes the processor to implement a method as in any of Examples 1-18.

What is claimed is:

1. A method of wireless communication at a first wireless device, comprising:
communicating, with a second wireless device, a cell-switching command (CSC) including a first indication type of a plurality of indication types, the first indication type for switching from a source cell to a candidate cell; and
performing, with the second wireless device, a lower-layer triggered mobility (LTM) procedure according to the first indication type.

2. The method of claim 1, wherein the first indication type includes a prediction-based indication and a second indication type of the plurality of indication types includes a non-prediction-based indication.

3. The method of claim 1, wherein the communicating the CSC, comprises:
receiving, from the second wireless device, the CSC to switch the first wireless device from the source cell to the candidate cell.

4. The method of claim 1, wherein the communicating the CSC, comprises:
transmitting, to the second wireless device, the CSC to switch the second wireless device from the source cell to the candidate cell.

5. The method of claim 1, wherein the communicating the CSC, comprises:
transmitting, to the second wireless device, the CSC to switch the first wireless device from the source cell to the candidate cell.

6. The method of claim 1, wherein the communicating the CSC, comprises:
receiving, from the second wireless device, the CSC to switch the second wireless device from the source cell to the candidate cell.

7. The method of claim 1, wherein the first indication type is associated with a sequence of LTM procedures for the switching from the source cell to a plurality of candidate cells in sequence, wherein the sequence of LTM procedures includes the LTM procedure, and wherein the plurality of candidate cells includes the candidate cell.

8. The method of claim 7, wherein the CSC triggers the sequence of LTM procedures based on a plurality of candidate cell configuration identifiers (IDs) for the plurality of candidate cells being included in the CSC.

9. The method of claim 7, wherein the CSC is one of a plurality of CSCs, further comprising:
communicating, with the second wireless device, the plurality of CSCs on a same physical shared channel, each CSC of the plurality of CSCs including a respective first indication type to trigger the sequence of LTM procedures.

10. (canceled)

11. (canceled)

12. The method of claim 1, further comprising:
communicating, with the second wireless device, a validation signal confirming the first indication type in the CSC.

13. The method of claim 1, further comprising:
communicating, with the second wireless device, a second CSC that provides an update to the first indication type, the performing the LTM procedure being based on the update to the first indication type, wherein the second CSC includes a prediction-based indication or a non-prediction-based indication for the switching from the source cell to the candidate cell.

14. (canceled)

15. The method of claim 1, further comprising:
communicating, with the second wireless device, a user equipment (UE) capability message indicating a capability of a UE for the performing the LTM procedure according to the first indication type.

16. The method of claim 1, further comprising:
communicating with the second wireless device, a configuration enabling the a user equipment (UE) to perform the LTM procedure according to the first indication type.

17. The method of claim 1, wherein the first wireless device is a user equipment (UE) and the second wireless device is a network entity.

18. The method of claim 1, wherein the first wireless device is a network entity and the second wireless device is a user equipment (UE).

19. (canceled)

20. An apparatus for wireless communication at a first wireless device, comprising:
a transceiver;
a memory; and
a processor coupled to the memory and the transceiver, the processor configured to:
communicate, with a second wireless device, a cell-switching command (CSC) including a first indication type of a plurality of indication types, the first indication type for switching from a source cell to a candidate cell; and
perform, with the second wireless device, a lower-layer triggered mobility (LTM) procedure according to the first indication type.

21. The apparatus of claim 20, wherein the first indication type includes a prediction-based indication and a second indication type of the plurality of indication types includes a non-prediction-based indication.

22. The apparatus of claim 20, wherein to communicate the CSC, the processor is configured to:
receive, from the second wireless device, the CSC to switch the first wireless device from the source cell to the candidate cell.

23. The apparatus of claim 20, wherein to communicate the CSC, the processor is configured to:
transmit, to the second wireless device, the CSC to switch the second wireless device from the source cell to the candidate cell.

24. The apparatus of claim 20, wherein to communicate the CSC, the processor is configured to:
transmit, to the second wireless device, the CSC to switch the first wireless device from the source cell to the candidate cell.
